(19) United States
(12) Patent Application Publication
(10) Pub. No.: US 2005/0264048 A1
(43) Pub. Date: Dec. 1, 2005

(54) Seat and cargo carrier apparatus

(76) Inventor: Harry Stephen Collins, Moore, OK (US)

Correspondence Address: DUNLAP, CODDING & ROGERS P.C., PO BOX 16370, OKLAHOMA CITY, OK, 73113, US

(21) Appl. No.: 10/814,394

(22) Filed: Mar. 31, 2004

(51) Int. Cl. B60P 7/02; A47C 7/62

(52) U.S. Cl. 297/188.01

(57) ABSTRACT

The present invention is directed to a seat and cargo carrier apparatus for a vehicle. The seat and cargo carrier apparatus includes a base, a seat assembly, and a wall unit. The seat member is pivotally connected to the base so that the seat assembly is movable between a seating position and a cargo carrying position. In the seating position, the seat assembly provides a seat or bench on which an individual may sit. In the cargo carrying position, the seat assembly is pivoted to provide a deck on which cargo may be carried. The wall unit is also pivotally connected to the base so that the wall unit is moveable between a lowered position and a raised position. In the lowered position, the wall unit provides a step and footrest when the seat assembly is in the seating position. In the raised position, the base the seat assembly and the wall unit cooperate to form a cargo box for securing cargo positioned on the deck.

### BACKGROUND OF THE INVENTION

1. Field of the Invention

The present invention relates generally to vehicles, such as golf cars, and more particularly, but not by way of limitation, to an improved seat and cargo carrier apparatus for a vehicle.

2. Brief Description of Related Art

A variety of utility and specialty vehicles are used to accommodate the specific needs of various endeavors. Golf courses, airports, and factories are examples of enterprises that use special purpose vehicles to move goods and transport passengers from one place to another. The market for any particular model of this type of off-road vehicle is relatively small compared to the size of the market for vehicles used for highway transportation, agriculture, construction, and the like.

Passenger vehicle and cargo vehicle designers have attempted to expand the range of purposes for which particular vehicles may be used. Availability of optional configurations or features that allow a vehicle to fulfill additional needs beyond a primary one can greatly increase the functionality of a vehicle and enhance the value of the vehicle to the owner. Some vehicles have features that allow passenger-carrying spaces to convert to a cargo-carrying mode. For example, it is an established practice to provide automobile seat backs that fold down to accommodate cargo. However, none of the utility vehicles known in the art satisfactorily provide both passenger-carrying and load-carrying capacity. Similarly, none of the vehicles provide a system that allows the conversion of passenger-carrying space to cargo-carrying space and back with sufficient quickness and ease to make it practical to do so several times during each day.

To this end, a need exists for an apparatus that is capable of supporting passengers on seats and that is quickly convertible for carrying cargo. It is to such an apparatus that the present invention is directed.

### BRIEF DESCRIPTION OF THE SEVERAL VIEWS OF THE DRAWINGS

FIG. 1 is a perspective view of a vehicle shown with a seat and cargo carrier apparatus constructed in accordance with the present invention shown in a seating position.

FIG. 2 is a perspective view of the vehicle of FIG. 1 shown with the seat and cargo carrier in a first cargo carrier position.

FIG. 3 is a perspective view of the vehicle of FIG. 1 shown with the seat and cargo carrier apparatus in a second cargo carrier position.

FIG. 4 is a partially cutaway, perspective view of a base of the seat and cargo carrier apparatus.

FIG. 5 is a bottom plan view of the base.

FIG. 6 is an exploded view of a seat assembly.

FIG. 7 is a perspective view of a wall structure shown with a rear wall in a lowered position.

FIG. 8 is an end view of the wall structure shown with the rear wall in a raised position.

FIG. 9 is a perspective view of a bracket assembly.

FIG. 10 is a side view of the seat and cargo carrier apparatus shown connected to the vehicle with the bracket assembly of FIG. 9.

FIG. 11 is a perspective view of another embodiment of a bracket assembly.

FIG. 12 is a side view of the seat and cargo carrier apparatus shown connected to another vehicle with the bracket assembly of FIG. 11.

### DETAILED DESCRIPTION OF THE INVENTION

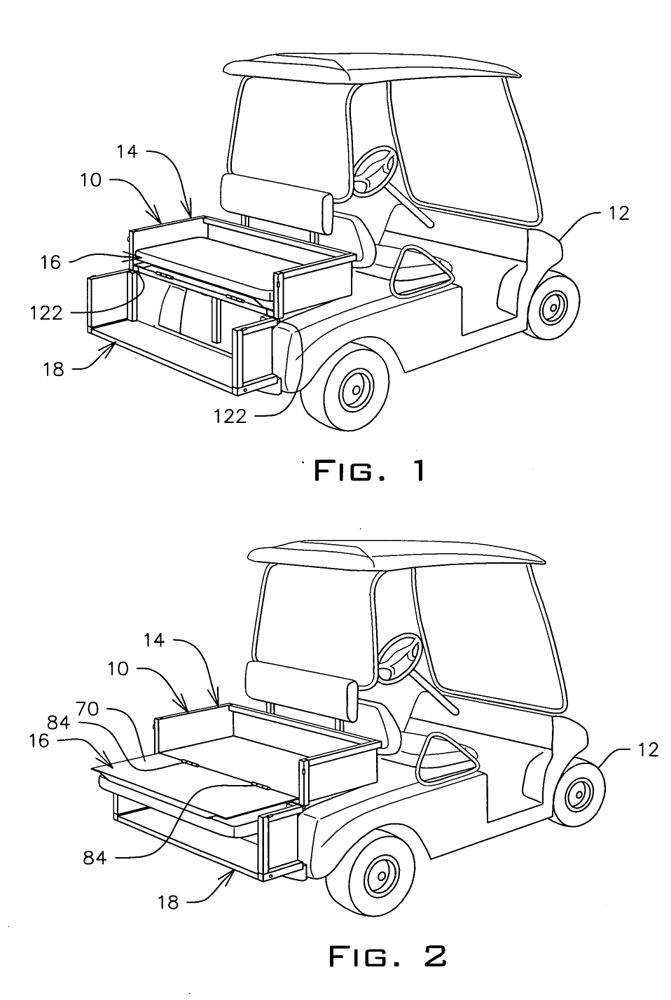

Referring now to the drawings, and more particularly to FIGS. 1-3, a seat and cargo carrier apparatus 10 constructed in accordance with the present invention is shown mounted on a vehicle 12. The vehicle 12 is illustrated as being a golf car, but it should be appreciated that the use of the seat and cargo apparatus 10 of the present invention is not limited to these types of vehicles. The seat and cargo carrier apparatus 10 may be used with other types of vehicles, such as utility vehicles and all-terrain vehicles.

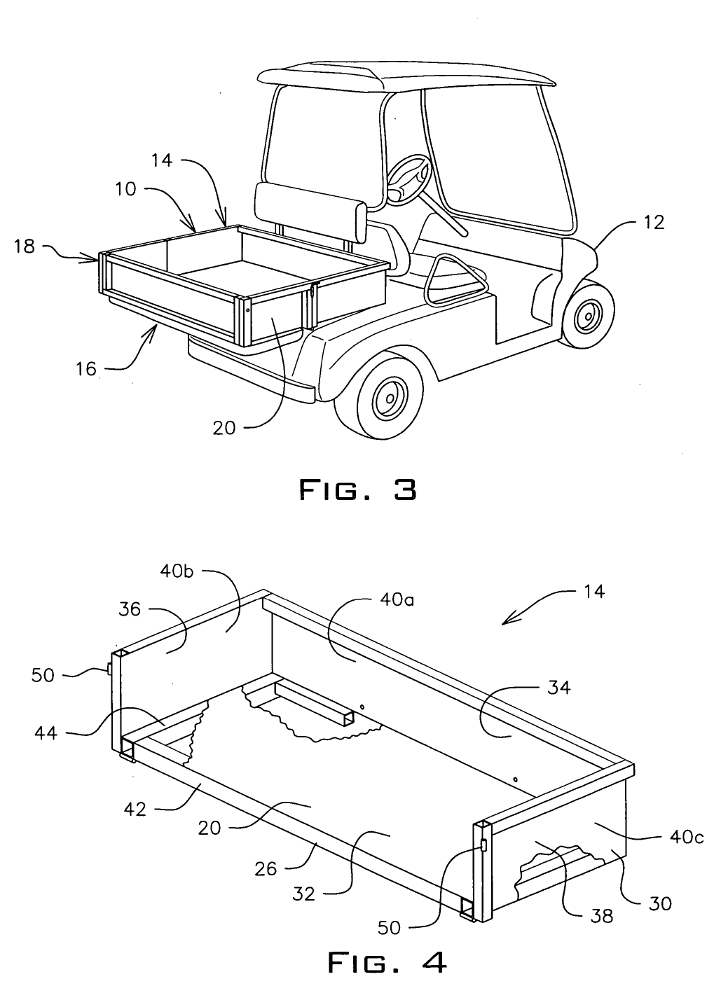

The seat and cargo carrier apparatus 10 is adapted to be detachably mounted to the vehicle 12. But, the seat and cargo carrier apparatus 10 may also be integrated into the structure of the vehicle 12, as well as other types of vehicles. The seat and cargo carrier apparatus 10 includes a base 14, a seat assembly 16, and a wall unit 18. The seat assembly 16 is pivotally connected to the base 14 so that the seat assembly 16 is movable between a seating position (FIG. 1) and a cargo carrying position (FIG. 2). In the seating position, the seat assembly 16 provides a seat or bench on which an individual may sit. In the cargo carrying position, the seat assembly 16 is pivoted approximately 180° to provide a deck on which cargo may be carried (FIG. 2). The wall unit 18 is also pivotally connected to the base 14 so that the wall unit 18 is moveable between a lowered position (FIGS. 1 and 2) and a raised position (FIG. 3). In the lowered position, the wall unit 18 provides a step and footrest when the seat assembly 16 is in the seating position. In the raised position, the base 14, the seat assembly 16, and the wall unit 18 cooperate to form a cargo box 20 (FIG. 3) for securing cargo positioned on the deck.

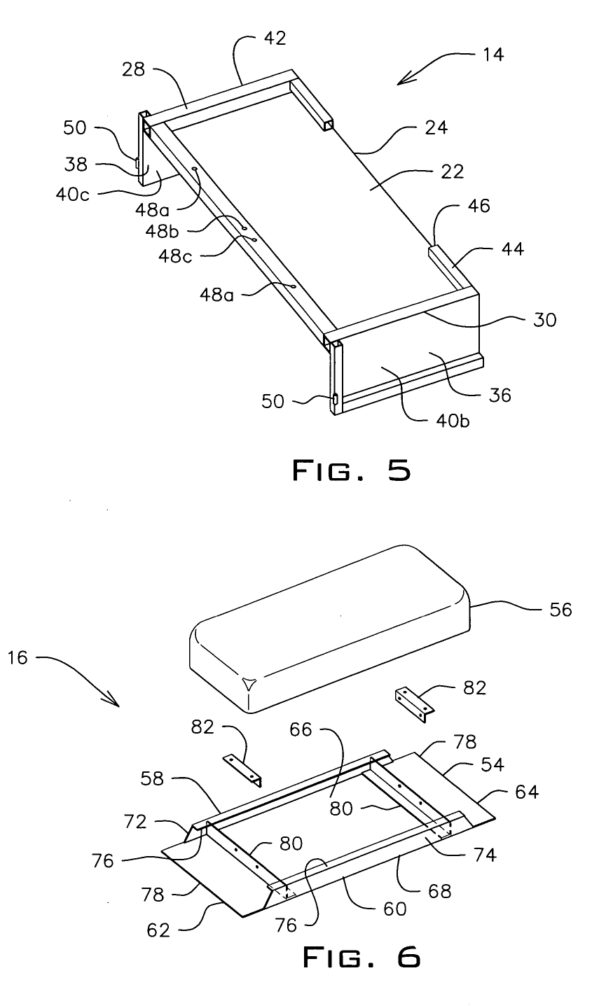

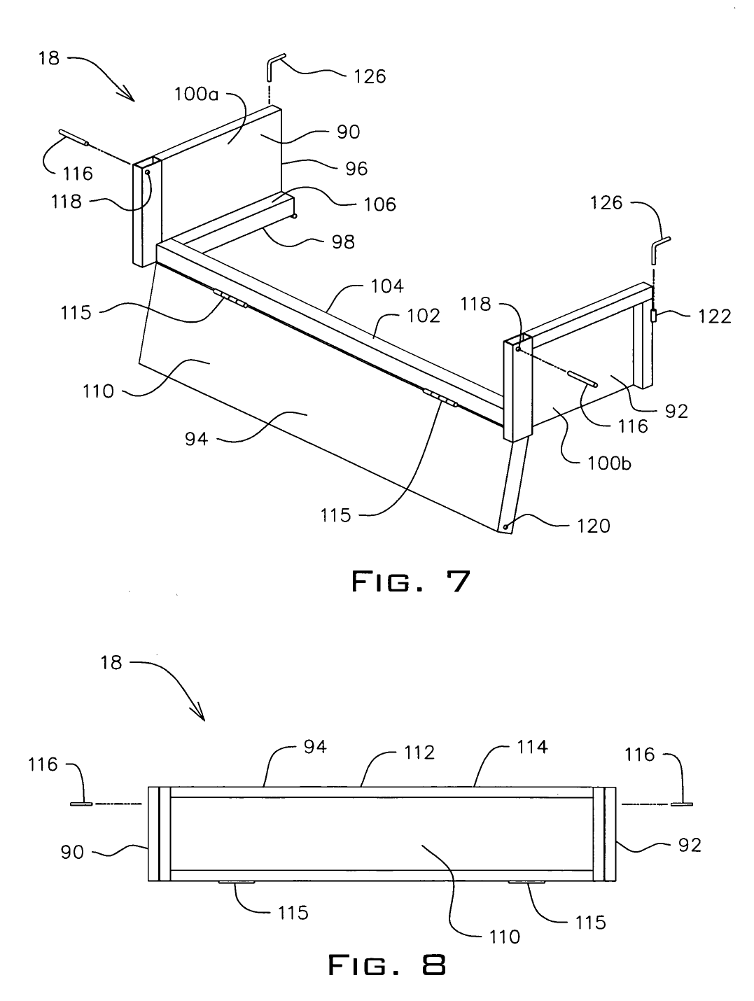

Referring now to FIGS. 4 and 5, the base 14 has an upper side 20 (FIG. 4), a lower side 22 (FIG. 5), a forward end 24, a rearward end 26, a first side 28, and a second side 30. The upper side 20 is a generally flat surface defining a base support deck 32. The base 14 further has a front wall 34 extending upwardly from the forward end 24, a first sidewall 36 extending upwardly from the first side 28, and a second sidewall 38 extending upwardly from the second side 30.

The base support deck 32, the first sidewall 36, the second sidewall 38, and the front wall 34 are constructed of panels 40a-40c, respectively, secured to a base frame 42. The base frame 42 is constructed of a plurality of rigid frame members 44 secured to one another in a suitable fashion, such as by welding. The base frame 42 is provided with an opening 46 (FIG. 5) on a forward end of the base frame 42. The opening 46 is provided for receiving a mounting bracket to be described in detail below. A frame member 44a is provided with a plurality of threaded holes 48a-48c for facilitating connection of different mounting brackets to the base 14. The frame members 44 are preferably constructed of a square-shaped, steel tubing, but the frame members may be constructed of any rigid, high strength material. The panels 40 are preferably constructed of rigid, high strength material, such as a 16 gauge steel sheet, and secured to the base frame 42 by welding, or by some other suitable fashion.

A collar 50 is secured to the base 14 at the rear end of the first sidewall 36 and the second sidewall 38. Each collar 50 has a pin receiving opening extending through the collar 50.

As best shown in FIG. 6, the seat assembly 16 includes a seat member 54 and a seat cushion 56. The seat member 54 is preferably constructed of a rigid, high strength material, such as a 16 gauge steel sheet. The seat member is characterized as having a forward end 58, a rearward end 60, a first side 62, a second side 64, an upper side 66, and a lower side 68. The lower side 68 of the seat member 54 is a generally flat surface forming a seat member support deck 70 (FIG. 2). A flange 72 is formed at the forward end 58 and a flange 74 is formed at the rearward end 60 by forming a downward bend in the sheet material. A lip 76 is further formed on the end of each of the flanges 72 and 74. The ends of the flanges 72 and 74 are spaced a distance from the first and second sides 62 and 64 of the seat member 54 so that a pair of wing members 78 are defined. The wing members 78 extend along the first and second sides 62 and 64 thereof.

The flanges 72 and 74 are reinforced by a pair of braces 80 extending between the flanges 72 and 74 in a spaced apart, parallel relationship with the ends of the flanges positioned under the lips 76. The braces 80 are illustrated herein as being angle iron, but it should be appreciated that the braces 80 may be constructed of any rigid, high strength material. Also, the number of braces 80 may be varied so long as the flange 74 at the rearward end 60 is adequately supported.

The seat cushion 56 is secured to the upper side 66 of the seat member 54 in a suitable manner, such as with a pair of brackets 82. More preferably, the seat cushion 56 is secured to the braces 80 with the brackets 82.

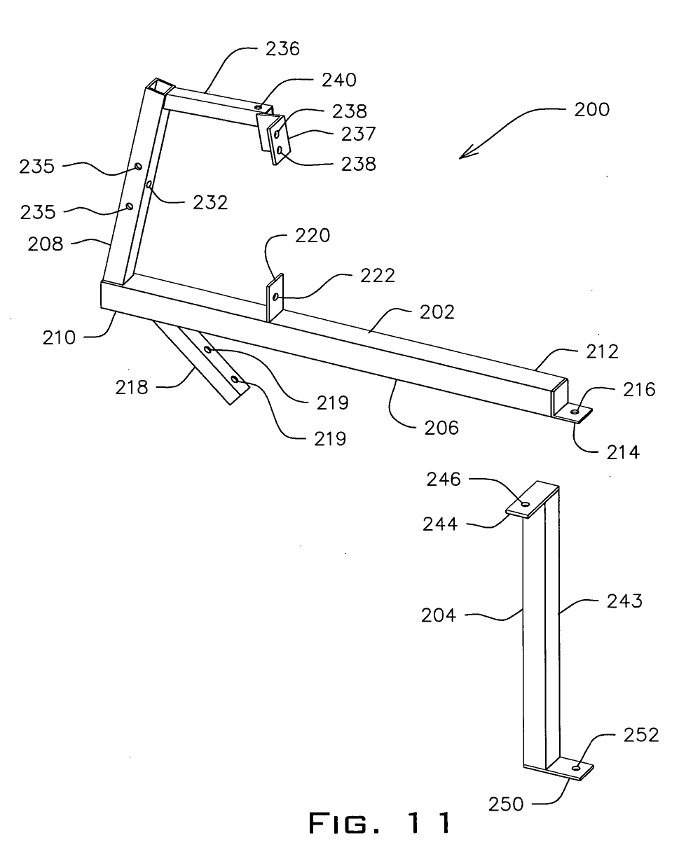

The seat member 54 is pivotally connected to the base 14 with a pair of hinges 84 (FIG. 2) so that the seat member 54 is movable between the seating position (FIG. 1) and the cargo carrying position (FIG. 2). In the seating position, the seat member 54 is positioned on top of the base 14 with the seat member support deck 70 arranged in a face to face relationship with respect to the base support deck 32. In the cargo carrying position, the seat member 54 is positioned so that the seat member support deck 70 is in a substantially coplanar relationship with the base support deck 32. As best shown in FIG. 10, the flange 74 of the seat member 54 abuttingly engages the rearward end 26 of the base 14 to support the seat assembly 16 in the cargo carrying position. Because the flange 74 is reinforced with the braces 80, no additional external support members are needed to support the seat assembly 16 in the cargo carrying position when the seat and cargo carrier apparatus 10 is used with a lightweight vehicle, such as a golf car, because the front end of a lightweight vehicle will be lifted off the ground if too much weight is attempted to be placed on the seat member support deck 70. However, should one use the seat and cargo carrier apparatus 10 on a heavier vehicle with the intention of carrying heavy loads, additional support may be required for the seat assembly 16.

FIGS. 7 and 8 best illustrate the wall unit 18. The wall unit 18 has a first sidewall 90, a second sidewall 92, a rear wall 94, an open forward end 96, and an open bottom 98. The first sidewall 90 and the second sidewall 92 are constructed of panels 100a and 100b, respectively, secured to a sidewall frame 102. The sidewall frame 102 is constructed of a plurality of rigid frame members 104 secured to one another in a suitable fashion, such as by welding. The sidewall frame 102 is constructed to provide a pair of opposing internal shoulders 106 and 108 (only the internal shoulder 106 being visible in FIG. 7) extending along a lower end of the interior side of the first and second sidewalls 90 and 92.

The rear wall 94 is preferably constructed to function as a tailgate and a step. To this end, the rear wall 94 is constructed of a panel 110 secured to a rear wall frame 112. Like the sidewall frame 102, the rear wall frame 112 is constructed of a plurality of rigid frame members 114 secured to one another in a suitable fashion, such as by welding. The rear wall frame 112 is pivotally connected to the sidewall frame 102 with a pair of hinges 115 so that the rear wall 94 of the wall unit 18 is movable relative to the first sidewall 90 and the second sidewall 92 of the wall unit 18 between a raised position and a lowered position. The rear wall 94 is secured in the raised position with a pin 116 inserted through axially aligned holes 118 and 120 formed through the sidewall frame 102 and the rear wall frame 112, respectively.

The open forward end 96 of the wall unit 18 is pivotally connected to the base 14 with a pair of hinges 122 so that the wall unit 18 is moveable between a lowered position (FIGS. 1 and 2) and a raised position (FIG. 3). In the raised position the wall unit 18 cooperates with the first sidewall 36, the second sidewall 38 and the front wall 34 of the base 14 to form the cargo box 20. When the seat member 16 is in the cargo carrying position, the seat cushion 56 extends through the open bottom 98 of the wall unit 18 and the wing members 78 of the seat member 54 engage the internal shoulders 106 and 108 of the wall unit 18 whereby the base support deck 32 and the seat member support deck 70 cooperate to form the bottom of the cargo box. In the lowered position, the wall unit 18 may rest against a portion of the vehicle 12 so that the wall unit 18 is supported and thus the rear wall 94 of the wall unit 18 is able to be used as a step for facilitating an individual getting on and off the seat cushion 56 and a foot rest while the individual is sitting on the seat cushion 56.

A collar 122 is secured to the wall unit 18 at the front end of the first sidewall 90 and the second sidewall 92. Each collar 122 has a pin receiving opening extending through the collar 122. The collars 122 are secured to the wall unit 18 so as to be axially aligned with the openings of the collars 50 of the base 14 when the wall unit 18 is in the raised position. The wall unit 18 is secured in the raised position by inserting a pin 126 through the aligned openings of the collars 50 and 122.

It should be appreciated by those of ordinary skill in the art that numerous makes and models of vehicles exist on which the seat and cargo carrier apparatus 10 of the present invention may be utilized. Consequently, the manner in which the seat and cargo apparatus 10 is mounted to any such vehicle will also vary widely. However, it is preferable to utilize a bracket assembly that permits the seat and cargo carrier apparatus 10 to be quickly and easily installed on a vehicle without requiring structural modification of the vehicle. Also, from a manufacturing standpoint it is desirable to be able to utilize a bracket assembly that is designed to fit different types vehicles being utilized in the marketplace. To this end, it will be appreciated that golf cars sold under the trademark E-Z-GO® and CLUB CAR® comprise a large percentage of the golf car market and have similarities in their structures. Therefore, it would be desirable to mount the seat and cargo carrier apparatus 10 to either of these types of vehicles utilizing the same bracket assembly.

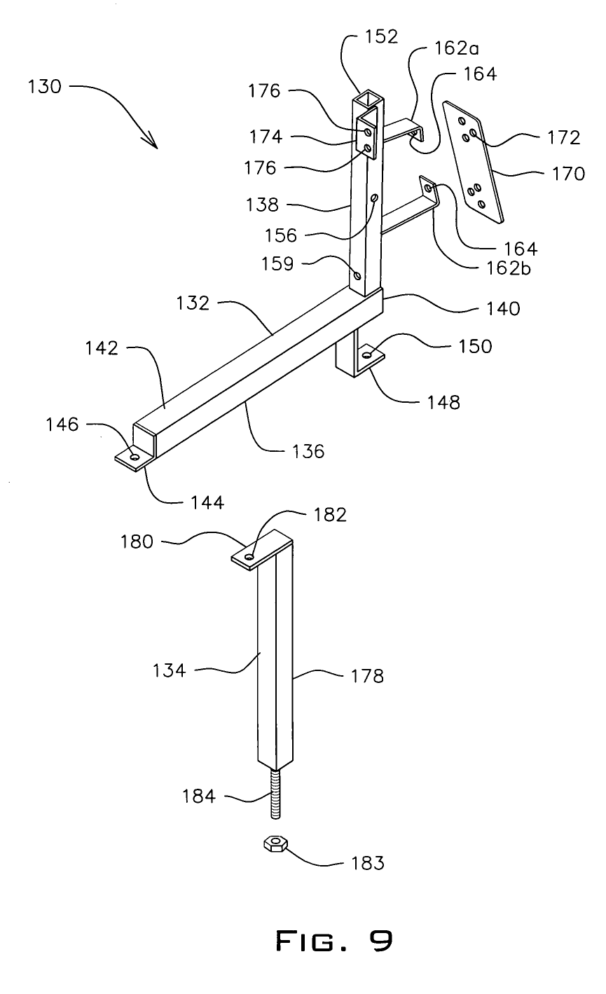

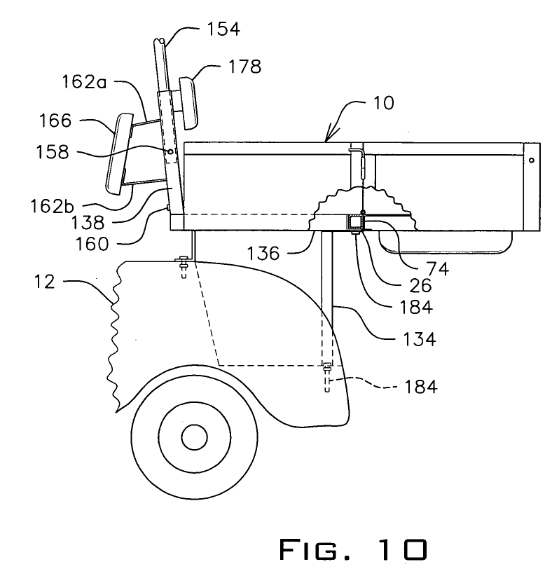

Referring now to FIGS. 9 and 10, a bracket assembly 130 for securing the seat and cargo carrier apparatus 10 to the vehicle 12 is illustrated. The vehicle 12 illustrated in FIGS. 1-3 is intended to represent an E-Z-GO® golf car, model no. TXT. The bracket assembly 130 includes a mounting bracket 132 and a support leg 134. In mounting the seat and cargo carrier apparatus 10 to the vehicle 12, two mounting brackets 132 (a left mounting bracket and a right mounting bracket) and one support leg 134 are utilized. The mounting bracket 132 illustrated in FIG. 9 is the left or driver side mounting bracket 132. The right mounting bracket is a mirror image of the left mounting bracket. Therefore, only the left mounting bracket 132 will be described in detail herein.

The mounting bracket 132 is a substantially L-shaped member having a horizontal member 136 and a vertical member 138. The horizontal member 136 is characterized as having a proximal end 140 and a distal end 142. The distal end 142 of the horizontal member 136 is provided with a mounting flange 144 with an attachment hole 146. The attachment hole 146 is alignable with one of the holes 48a of the base 14. The hole 48a is positioned in the base 14 so that the horizontal member 136 extends through the opening 46 of the base frame 42 and along the lower side 22 of the base 14. The horizontal member 136 is further provided with a mounting flange 148 extending downwardly near the proximal end 140 thereof. The mounting flange 148 is provided with an attachment hole 150 alignable with a bracket attachment opening (not shown) provided in the frame of the vehicle 12.

The vertical member 138 extends upwardly from the proximal end 140 of the horizontal member 136 at an angle of approximately 90 to 100 degrees. The vertical member 138 is a tubular member with an open upper end 152 sized and configured to receive a lower end of a canopy support member 154 (FIG. 10) of the vehicle 12. The vertical member 138 includes a hole 156 for securing the canopy support member 154 within the vertical member 138 with a connector member 158, such as a nut and bolt combination. The vertical member 138 further includes a hole 159 near the lower end thereof for connecting the vertical member 138 to the front wall 34 of the base 14 with a connector member 160.

A pair of mounting flanges 162a and 162b extend outwardly from a front end of the vertical member 138. Each of the mounting flanges 162a and 162b has attachment holes 164. The mounting flanges 162a and 162b are sized and spaced for connection to a forward seat back 166 of the vehicle. The seat back 166 of the vehicle 12 is typically provided with a vertical groove (not shown) formed along the back side of the seat back 166 for receiving a seat back support bracket. The mounting flanges 162a and 162b are sized to be matingly received within the groove. For example, the size of the groove in certain makes and models is approximately 1 inch wide, therefore, the width of the mounting flange is approximately 1 inch. However, certain makes and models of golf cars have a seat back with a groove approximately 2 inches wide. In those circumstances an adapter plate 170 sized to be matingly received in the two inch groove may be utilized. The adapter plate 170 is provided with a series of attachment holes 172 for attachment to the mounting flanges 162a and 162b and the seat back 166.

A mounting flange 174 extends rearwardly from the vertical member 138 near the upper end thereof. The mounting flange 174 has a pair of attachment holes 176 for attaching a seat back 178 (FIG. 10) which may be utilized by an individual seated on the seat assembly 16.

The support leg 134 is used to support the rearward end 26 of the base 14. The support leg 134 includes a leg member 178 provided with a support flange 180 with an attachment hole 182 at an upper end thereof, and a connector member 184 at a lower end thereof. The connector member 184 is disposable through an opening provided in the vehicle 12. The leg member 178 may be secured to the vehicle 12 with a nut 183. The support flange 180 is secured to the base 14 with a connector member 184, such as a bolt by aligning the attachment hole 182 with the hole 48b of the base 14. It will be appreciated by those of ordinary skill in the art that the position of the hole of the vehicle 12 may be different depending on the make and model of the vehicle 12. For example on an E-Z-GO® golf car, the hole is centered along the rear end vehicle 12. Therefore, the attachment hole 182 of the supporting flange 180 is aligned with the hole 48b of the base 14, which is centered on the base 14. In the case of a CLUB CAR® golf car, model no. DCS, the hole of the vehicle is offset from the center. Therefore, when attaching the supporting leg 134 to a CLUB CAR® golf car, the attachment hole 182 of the supporting flange 180 is aligned with the hole 48c of the base 14.

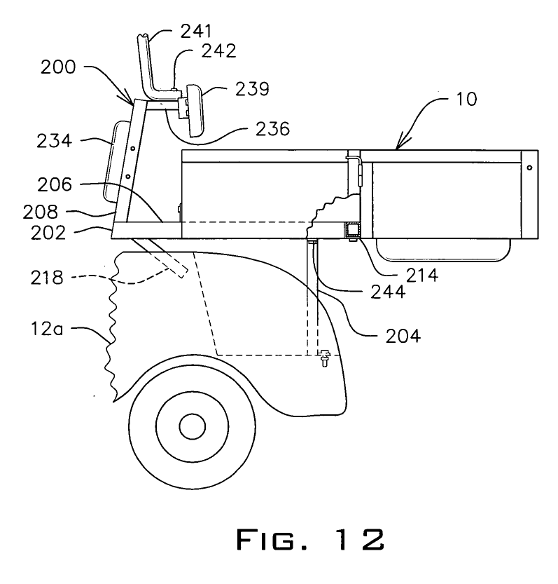

Referring now to FIGS. 11 and 12, another embodiment of a bracket assembly 200 for securing the seat and cargo carrier apparatus 10 to a vehicle 12a is illustrated. The vehicle 12a illustrated in FIG. 12 is intended to represent a YAMAHA® golf car, such as model nos. G14-G20. The bracket assembly 200 includes a mounting bracket 202 and a support leg 204. In mounting the seat and cargo carrier apparatus 10 to the vehicle 12a, two mounting brackets 202 (a left mounting bracket and a right mounting bracket) and two support legs 204 are preferably utilized. The mounting bracket 202 shown in FIG. 11 is the right or passenger side mounting bracket 202. The left mounting bracket is a mirror image of the left mounting bracket 202.

The mounting bracket 202 is a substantially L-shaped member having a horizontal member 206 and a vertical member 208. The horizontal member 206 is characterized as having a proximal end 210 and a distal end 212. The distal end 212 of the horizontal member 206 is provided with a mounting flange 214 with an attachment hole 216. The attachment hole 216 is alignable with the hole 48a of the base 14. The hole 48a is positioned in the base 14 so that the horizontal member 206 extends through the opening 46 of the base frame 42 and along the lower side 20 of the base 14. The horizontal member 206 is further provided with a mounting leg 218 extending downwardly and angularly from the horizontal member 206 near the proximal end 210 thereof. The mounting leg 218 is adapted to be slidingly received in angled bracket receiving opening (not shown) formed in the vehicle 12a. The mounting leg 218 is provided with attachment holes 219 for securing the mounting leg 218 within the angled opening of the vehicle 12a.

The length of the vehicle 12a is greater than the length of the vehicle 12. Therefore, the horizontal member 206 is further provided with a mounting flange 220 which is spaced a distance from the proximal end 210 of the horizontal member 206. The mounting flange 220 has an attachment hole 222 for the attachment of the mounting flange 220 to the front wall 34 of the base 14.

The vertical member 208 extends upwardly from the proximal end 210 of the horizontal member 206 at an angle of approximately 90 to 100 degrees to accommodate the angle of a forward back rest 234 (FIG. 12). The vertical member 208 includes a hole 232 at an intermediate portion thereof for connecting the vertical member 208 to the forward seat back 234 of the vehicle 12a. The vertical member 208 vertical includes a pair of holes 235 for attaching a lower portion of a canopy support member (not shown) for Yamaha® golf cars manufactured since the model year 2002. The lower end of the canopy support member extends along the side of the vertical member 208 and secured thereto with a connector member, such as a nut and bolt.

An extension member 236 is connected to an upper end of the vertical member 208 such that the extension member 236 extends rearwardly. The end of the extension member 236 is provided with a mounting flange 237. The mounting flange 237 has a pair of attachment holes 238 for attaching a seat back 239 (FIG. 12) which may be utilized by an individual seated on the seat assembly 16. The extension member 236 further includes a hole 240 for securing a lower end of a canopy support member 241 of the vehicle 12a. With Yamaha® golf cars manufactured prior to the model year 2002, the lower end of the canopy support member 241 is positioned on top of the extension member 236 in a substantially parallel relationship. Prior to installation of the seat and cargo carrier apparatus 10, the length of the canopy support member 241 may need to be shortened approximately 2 inches to accommodate the rear seat back 239. The canopy support member 241 is secured to the extension member 236 with a connector member 242, such as a nut and bolt combination. The support legs 204 are mirror images of one another. To this end, only the left support leg 204 will be described in detail herein. The support legs 204 are used to support the rearward end 26 of the base 14. The support legs include a leg member 243 provided with a mounting flange 244 with an attachment hole 246 at an upper end thereof, a mounting flange 250 with an attachment hole 252 at a lower end thereof. The attachment holes 252 are alignable with opposing openings provided near the rear end of the vehicle 12a. A suitable connector, such as a nut and bolt, may be used to secure the leg member 244 to the vehicle 12a. The mounting flange 244 is secured to the bottom of the horizontal member 206 base 14 with a connector member, such as a bolt, by aligning the attachment hole 246 with a hole (not shown) provided in the horizontal member 206 of the base 14.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

1. A seat and cargo carrier apparatus for a vehicle, comprising:
a base having an upper side defining a base support deck, a forward end, a rearward end, a first side, and a second side, the base connectable to the vehicle; and
a seat member having a forward end, a rearward end, and upper side, and a lower side, the lower side forming a seat member support deck, the rearward end of the seat member having a flange extending along at least a portion thereof and supported by a brace extending between the forward end and the rearward end of the seat member, the seat member pivotally connected to the base so that the seat member is movable between a seating position and a cargo carrying position, in the seating position the seat member positioned on top of the base with the seat member support deck arranged in a face to face relationship with respect to the base support deck and in the cargo carrying position the seat member positioned so that the flange at the rearward end of the seat member abuttingly engages the rearward end of the base and the seat member support deck is in a substantially coplanar relationship with the base support deck.

2. The apparatus of claim 1 wherein the forward end of the seat member has a flange extending along at least a portion thereof and wherein the brace extends between the flange of the forward end and the flange of the rearward end.

3. The apparatus of claim 1 wherein the base has a front wall extending upwardly from the forward end, a first sidewall extending upwardly from the first side, and a second sidewall extending upwardly from the second side, and wherein the apparatus further comprises a wall unit having a first sidewall, a second sidewall, a rear wall, an open forward end, and an open bottom, the open forward end of the wall unit pivotally connected to the base so that the wall unit is moveable between a lowered position and a raised position, in the raised position the wall unit cooperating with the first sidewall, the second sidewall and the front wall of the base to form a cargo box wherein the base support deck and the seat member support deck cooperate to form a bottom of the cargo box.

4. The apparatus of claim 3 wherein at least a portion of the rear wall of the wall unit is movable relative to the first sidewall and the second sidewall of the wall unit between a raised position and a lowered position.

5. The apparatus of claim 4 wherein at least a portion of the rear wall of the wall unit defines a step when the wall unit is in the lowered position.

6. The apparatus of claim 1 wherein the seat member further includes a seat cushion attached to the upper side thereof.

7. The apparatus of claim 1 wherein the wall unit is provided with an interior shoulder and wherein at least a portion of the seat member is positioned on the interior shoulder of the wall unit when the seal member is in the cargo carrying position and the wall unit is in the raised position.

8. A seat and cargo carrier apparatus for a vehicle, comprising:
a base having an upper side defining a base support deck, a forward end, a rearward end, a first side, and a second side, the base further having a front wall extending upwardly from the forward end, a first sidewall extending upwardly from the first side, and a second sidewall extending upwardly from the second side;
a seat member having a forward end, a rearward end, and upper side, and a lower side, the lower side forming a seat member support deck, the seat member pivotally connected to the base so that the seat member is movable between a seating position and a cargo carrying position, in the seating position the seat member positioned on top of the base with the seat member support deck arranged in a face to face relationship with respect to the base support deck and in the cargo carrying position the seat member positioned so that the seat member support deck is in a substantially coplanar relationship with the base support deck; and
a wall unit having a first sidewall, a second sidewall, a rear wall, an open forward end, and an open bottom, the open forward end of the wall unit pivotally connected to the base so that the wall unit is moveable between a lowered position and a raised position, in the raised position the wall unit cooperating with the first sidewall, the second sidewall and the front wall of the base to form a cargo box wherein the base support deck and the seat member support deck cooperate to form a bottom of the cargo box.

9. The apparatus of claim 8 wherein at least a portion of the rear wall of the wall unit is movable relative to the first sidewall and the second sidewall of the wall unit between a raised position and a lowered position.

10. The apparatus of claim 8 wherein the seat member further includes a seat cushion attached to the upper side thereof, and wherein the seat cushion extends through the open bottom of the wall unit when the seat member is in the cargo carrying position and the wall unit is in the raised position.

11. The apparatus of claim 8 wherein at least a portion of the rear wall of the wall unit defines a step when the wall unit is in the lowered position.

12. The apparatus of claim 8 wherein the wall unit is provided with an interior shoulder and wherein at least a portion of the seat member is positioned on the interior shoulder of the wall unit when the seal member is in the cargo carrying position and the wall unit is in the raised position.

13. A seat and cargo carrier apparatus for a vehicle, comprising:
a base having an upper side defining a base support deck, a forward end, a rearward end, a first side, and a second side, the base further having a front wall extending upwardly from the forward end, a first sidewall extending upwardly from the first side, and a second sidewall extending upwardly from the second side;
a seat member having a forward end, a rearward end, and upper side, and a lower side, the lower side forming a seat member support deck, the seat member pivotally connected to the base so that the seat member is movable between a seating position and a cargo carrying position, in the seating position the seat member positioned on top of the base with the seat member support deck arranged in a face to face relationship with respect to the base support deck and in the cargo carrying position the seat member positioned so that the seat member support deck is in a substantially coplanar relationship with the base support deck;
a wall unit having a first sidewall, a second sidewall, a rear wall, an open forward end, and an open bottom, the open forward end of the wall unit pivotally connected to the base so that the wall unit is moveable between a lowered position and a raised position, in the raised position the wall unit cooperating with the first sidewall, the second sidewall and the front wall of the base to form a cargo box wherein the base support deck and the seat member support deck cooperate to form a bottom of the cargo box; and
means for connecting the base to the vehicle.

14. The apparatus of claim 13 wherein the connecting means supports a forward back rest of the vehicle.

15. The apparatus of claim 13 wherein the connecting means supports a back rest for use in conjunction with the seat member.

16. The apparatus of claim 13 wherein at least a portion of the rear wall of the wall unit is movable relative to the first sidewall and the second sidewall of the wall unit between a raised position and a lowered position.

17. The apparatus of claim 13 wherein the seat member further includes a seat cushion attached to the upper side thereof, and wherein the seat cushion extends through the open bottom of the wall unit when the seat member is in the cargo carrying position and the wall unit is in the raised position.

18. The apparatus of claim 13 wherein at least a portion of the rear wall of the wall unit defines a step when the wall unit is in the lowered position.

19. The apparatus of claim 13 wherein the wall unit is provided with an interior shoulder and wherein at least a portion of the seat member is positioned on the interior shoulder of the wall unit when the seal member is in the cargo carrying position and the wall unit is in the raised position.

20. A seat and cargo carrier apparatus for a vehicle, comprising:
a base having an upper side defining a base support deck, a forward end, a rearward end, a first side, and a second side; and
means for connecting the base to the vehicle.

21. The apparatus of claim 20 further comprising:
a seat member having a forward end, a rearward end, and upper side, and a lower side, the lower side forming a seat member support deck, the seat member pivotally connected to the base so that the seat member is movable between a seating position and a cargo carrying position, in the seating position the seat member positioned on top of the base with the seat member support deck arranged in a face to face relationship with respect to the base support deck and in the cargo carrying position the seat member positioned so that the seat member support deck is in a substantially coplanar relationship with the base support deck.

22. The apparatus of claim 20 wherein the connecting means supports a forward back rest of the vehicle.

23. The apparatus of claim 20 wherein the connecting means supports a back rest for use in conjunction with the seat member.

24. The apparatus of claim 21 wherein the seat member further includes a seat cushion attached to the upper side thereof.
